(19) United States
(12) Patent Application Publication
(10) Pub. No.: US 2018/0093290 A1
(43) Pub. Date: Apr. 5, 2018

(54) DEVICE FOR COLMATING CORK STOPPERS

(71) Applicant: Reliable Cork Solutions, Unip. LDA, Lourosa (PT)

(72) Inventor: Hugo Guimarães, Lourosa (PT)

(73) Assignee: Reliable Cork Solutions, Unip. LDA, Lourosa (PT)

(21) Appl. No.: 15/566,153

(22) PCT Filed: Aug. 1, 2016
(86) PCT No.: PCT/IB2016/054618

§ 371 Date: Oct. 12, 2017

(30) Foreign Application Priority Data
Aug. 4, 2015 (PT) PT 108751

(51) Int. Cl. B05B 13/02; B27J 5/00; B27K 7/00

(52) U.S. Cl. CPC B05B 13/0207; B05C 11/02; B27K 7/00; B27J 5/00

(57) ABSTRACT

The present invention relates to a colmating improvement device for cork stoppers, comprising at least three cylindrical shaped rotating means, able to receive a cork stopper entering in a rotational movement with a slight pressure, which stopper is inserted through an insertion tubular device assisted by two pneumatic cylinders. The device further comprises two openings, an inlet opening and an outlet opening, two electric motors/reduction gears, a worm, a chain and a tank that can contain a substance consisting of a binder and cork dust with a solid content between 50 and 100%.

### INTRODUCTION

The natural cork stoppers, obtained solely from the usage of the bark of the cork oak, are then selected according to their porosity (number and size of pores) in several distinct qualities, usually nine.

Contrary to good quality corks (the first four categories), the middle and lower quality corks (last five categories) are not a product with an appealing appearance and hence not much sought after by the market.

The financial balance of the cork industry depends on the sale of all the qualities of cork in the resulting proportions by imposition of the raw material (natural product).

In summary, the real problem lies on the quantity and size of the pores in the medium and low quality stoppers. Aware of the problem described above, the cork industry sought to solve this problem by using colmating process.

According to APCOR, the Portuguese association for the cork industry, “the colmated stoppers are natural cork stoppers with pores (lenticels) filled exclusively with cork dust resulting of the trimming of natural cork stoppers. For the fixation of the powder in the pores, a natural resin and natural rubber based glued is used. Currently, in this process water based glue is also used.

The main purpose of the colmating is to improve both the visual aspect of the cork and its performance.

These stoppers have a rather homogenous visual appearance and good mechanical characteristics. They are manufactured in the most varied forms and dimensions. However, in the cylindrical shape, the most common measures ( . . . ) (length×diameter), although there may be variations according to the producer.”

The colmating operation used since always by the cork industry relies on the existence of a cylindrical drum with a capacity of several thousands cork stoppers where these are placed together with a mixture of adhesive and cork dust (among others) with a solid content in the range between 10 to 15%. This process ensures that the existing pores in the cork are filled with a mixture of cork dust and adhesive with a solid content in the range between 10 and 15%.

Other operations aimed to improve the technical features are also present in the cork industry. These operations apply essentially to the surface treatment. Similarly to the colmating process described above, the surface treatment of the cork stoppers consists in placing them in a drum with a capacity of several thousands stoppers, together with several coating products, ranging from silicones and derivatives to rubber compounds or even inks.

Despite the resolution of the problem consist effectively in the filling of the pores with a substance in accordance with food safety rules, and even in the treatment of the cork surface with the coating products, none of the processes used provides a significant improvement in the visual appearance of the medium and low quality natural cork stoppers. The resulting stopper of the existing processes (“B”), although more uniform and with a better technical performance, continues to show depressions on the surface thereof, causing the purchaser and the end user to be aware that this cork stopper was initially a medium or low quality one (“A”).

### STATE OF THE ART

Some documents that illustrate colmating and grinding process of cork stoppers are known from the prior art, which are substantially different from the invention proposed here.

The document PT 105043 discloses a colmating process comprising a tilting mechanical system with a solution of water at different temperatures, wherein the stoppers are placed in a drum where the dehumidifying and drying is carried out.

The document PT 106018 discloses a colmating process of aqueous base and very similar to that disclosed in the above document.

The document PT 2533957 discloses an improvement and trimming process of cork stoppers, wherein a lot of cork is impregnated with a liquid solution, subjected to a certain pressure and subsequently vacuum treated, ending with a heat treatment.

The present invention solves the technical problem of eliminating any surface defects and porosities in the cork stopper, effectively and without depressions on the surface of the stopper.

### DETAILED DESCRIPTION OF THE INVENTION

The invention consists essentially of three cylindrical shaped rotating means (5) rotating by the action of an electric motor/reduction gear (6) and pulled by a chain (7) with the same direction of rotation. The three cylindrical shaped rotating means (5) are aligned such that the rotation centres thereof form a triangle. The distance between the three inner faces of the cylindrical shaped rotating means (5) allows a stopper with a diameter x to pass between the three cylindrical shaped rotating means (5), even slightly under pressure. Once the stopper is slightly compressed between the cylindrical shaped rotating means (5) it assumes a rotary motion caused by the rotation of cylindrical shaped rotating means (5). The three cylindrical shaped rotating means (5) are permanently wrapped in substance consisting of a resin (or other binders) and cork dust (or others) in which the percentage of solid content is in the range of 50-100%. Therefore, when a stopper passes through a centre formed by the three cylindrical shaped rotating means (5) the substance wrapping the cork penetrates it. The cylindrical shaped rotating means (5) have a diameter not allowing the cork stopper to leave them, while allowing the substance to flow around. Due to the existing pressure between the assembly composed of rotating means-substance-stoppers, the substance penetrates substantially into the pores of the cork stoppers.

The length of the cylindrical shaped rotating means (5) must be such to allow the stopper to rotate several times, so that all the pores of the stopper are completely filled with the substance.

The diameter of the three cylindrical shaped rotating means (5), as well as the diameter of the inlet (4) and outlet (S) openings of the cork stoppers, as well as the distance between the centres of the three cylindrical shaped rotating means (5) must be readjusted depending on the diameter of the stopper to be processed. For a larger diameter cork stopper, the diameter of the cylindrical shaped rotating means (5) must be smaller and the diameter of the inlet (4) and outlet (S) openings of the stoppers must be larger. For a smaller diameter stopper, the diameter of the cylindrical shaped rotating means (5) must be larger and the diameter of the inlet (4) and outlet (S) openings of the cork stoppers must be smaller.

The cork stoppers enter through the insertion tubular device (1) and are placed against the pneumatic cylinders (2). By the action of the pneumatic cylinder (2) the cork stoppers are placed in front of the pneumatic cylinder (3). They are then pushed through the opening (4) and between the three cylindrical shaped rotating means (5) by the action of a piston (3) (which may be pneumatic or of another kind).

After the insertion of the first stopper, the next stoppers will be pushed one by the other.

At the end of the length of the cylindrical shaped rotating means (5) there is an opening (S) with the same diameter as the stopper, allowing the removal of the excess substance surrounding the stopper, while flushing the existing substance in the pores of the cork with the surface thereof.

There is a tank (10) for accumulation of the substance, comprising a resin (or other binders) and cork dust (or others) with a solid content in the range of [50-100%], wherein, by the action of the worm (9)/electric motor/reduction gear (8) assembly keeps the substance in a permanent mixture.

After the stabilization and drying of the substance, the cork stoppers are processed by customary dimensional correction means, creating a perfectly smooth surface where the pores are covered with the substance flushed with the surface of the stopper.

### BRIEF DESCRIPTION OF THE FIGURES

FIG. 1 is a perspective view of the trimming and improvement device for cork stoppers with all its components.

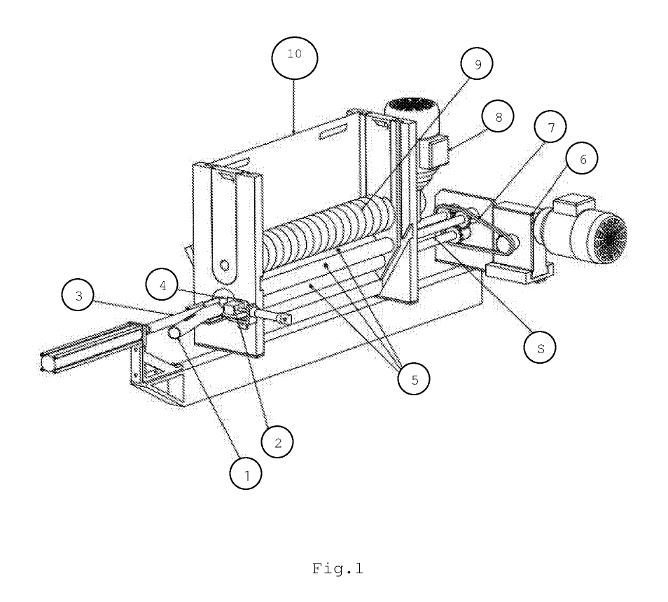

FIG. 2 is a top view of the device.

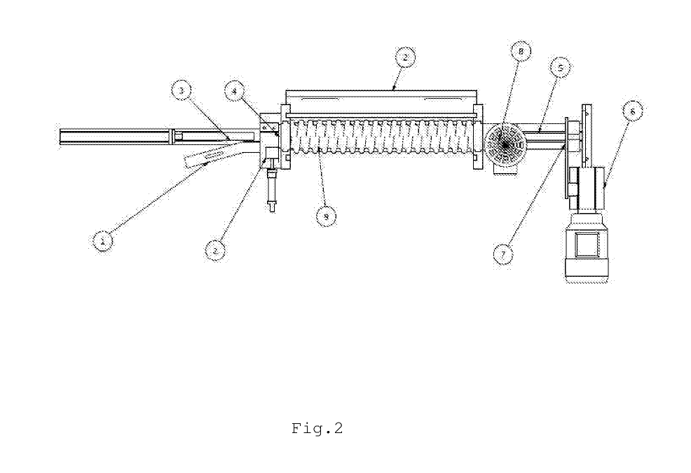

FIG. 3 is a view from the opposite side, where the electric motor/reduction gears (6 and 8) and the outlet opening (0) are visible in more detail.

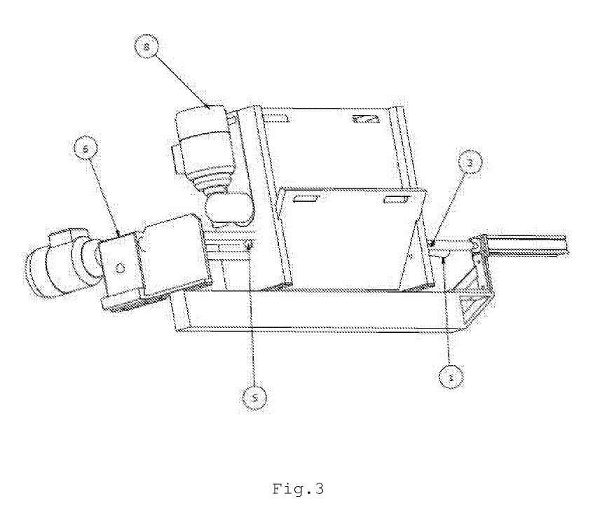

### LEGEND

1. Cork stopper insertion tube;

2. Pneumatic cylinder (A);

3. Pneumatic cylinder (B);

4. Input opening;

5. Cylindrical shaped rotating means;

6. Electric motor/reduction gear;

7. Chain;

8. Electric motor/reduction gear;

9. Worm;

10. Tank;

S. Outlet opening;

1.-7. (canceled)

8. A filling and improvement device for cork stoppers, comprising:
a cylindrical shaped rotating means able to form a triangle between its rotation centres, in order to press substantially a cork stopper and promote the rotation thereof;
an electric motor and reduction gear promoting the rotation of the cylindrical shaped rotation means and a chain that pulls them; and
an insertion tubular device placed at the entrance of a pneumatic cylinder assisting the entry of the stoppers into the device through the inlet opening where the stoppers are pushed by the action of a piston to the area of the cylindrical shaped rotating means and subsequently leaving through the outlet opening having a diameter equal to the cork stopper diameter.

9. A filling and improvement device for cork stoppers according to claim 8, characterized in that it is able to receive cylindrical rotating means and inlet and exit openings with different lengths and diameters, depending on the diameter of the stopper to be processed.

10. A filling and improvement device for cork stoppers according to claim 8, characterized in that the cylindrical shaped rotating means are in permanent contact with a substance comprised of binder with solid content of 50% to 100% and cork dust.

11. A filling and improvement device for cork stoppers according to claim 8, characterized in that the outlet opening with a diameter equal to the cork stopper removes substance in excess that surrounds the stopper and level the same substance with the cork stopper surface.

12. A filling and improvement device for cork stoppers according to claim 8, characterized in that the mixture of the substance is continuous throughout the process provided by the action of the worm, electric motor and reduction gear assembly in contact with the tank.

13. A cork stopper obtainable by device according to claim 8, characterized in that it comprises the totality of its porosity and lenticels filled with a substance comprised of binder with a percentage of solid content in the range of 50% to 100% and cork dust.

14. A cork stopper according to claim 13, characterized in that the uniform surface is guaranteed by the mechanical filling of its porosity and lenticels.
